(19) United States
(12) Patent Application Publication
(10) Pub. No.: US 2024/0061923 A1
(43) Pub. Date: Feb. 22, 2024

(54) ARTIFICIAL INTELLIGENCE BASED METHODS AND SYSTEMS FOR PERFORMING AUTHENTICATION OF A USER

(71) Applicant: Honey Badger HQ, Inc., Menlo Park, CA (US)

(72) Inventors: Matthew SALISBURY, Menlo Park, CA (US); Travis ROSCHER, Menlo Park, CA (US); Hon WONG, Menlo Park, CA (US); Joe HSY, Menlo Park, CA (US)

(21) Appl. No.: 17/891,490

(22) Filed: Aug. 19, 2022

(51) Int. Cl. G06F 21/36

(52) U.S. Cl. CPC G06F 21/36; G06F 2221/2103

(57) ABSTRACT

Embodiments of the present disclosure provide systems and methods for performing authentication of user. The method includes accessing a user profile including a plurality of data fields corresponding to a user from a database. The method further includes determining at least one data field from the plurality of data fields. The method further includes identifying a plurality of relevant data points associated with the at least one data field from one or more data repositories. The plurality of relevant data points identified is based on a relevance function. The method further includes selecting a plurality of unrelated data points from the one or more data repositories. The plurality of unrelated data points is unassociated with the at least one data field. Method further includes generating one or more user authentication requests. The one or more user authentication requests are generated based on the plurality of relevant and unrelated data points.

### TECHNICAL FIELD

The present disclosure relates to methods and systems for user identification and verification and, more particularly to, artificial intelligence-based methods and systems for performing authentication of a user.

### BACKGROUND

In recent times, identity fraud has become one of the biggest problems that businesses and service providers are facing. To address this problem, conventionally a number of checks and measures are employed, e.g., two-factor authentication, requiring passwords/pins, etc., are among the various measures employed by businesses to verify or authenticate the identity of a user. Although these measures are useful, they are not always applicable. For example, in various scenarios where the user is unable to access their account such as when two-factor authentication fails, the user forgets their password/pin, or if it's a new application from the user, there exists no user profile for performing the checks. Therefore, in such scenarios, the business or service provider has limited approaches for authenticating the identity of the user. An example of one such approach includes asking a series of static or pre-recorded questions to the user and judging their identity based on their responses.

However, there exists a fundamental flaw with such approaches, i.e., a hacker or a malicious entity may be able to successfully respond to these questions via various social engineering techniques such as phishing, pretexting, baiting, quid pro quo, tailgating, etc., among other malicious techniques. Further, there might even be a scenario where a valid user may simply forget the answers to their pre-recorded questions, thereby being unable to verify their identity despite being a genuine user. Such scenarios are known to cause tremendous risk and expense to the business or service provider due to activities such as financial fraud, identity theft, loss of revenue, user frustration, associated expenses, etc.

Therefore, there exists a need for technical solutions for authenticating the identity of a user with high accuracy and reliability while being cost-effective to implement.

### SUMMARY

Various embodiments of the present disclosure provide artificial intelligence-based methods and systems for performing authentication of a user.

In an embodiment, a computer-implemented method is disclosed. The computer-implemented method performed by a server system includes accessing a user profile including a plurality of data fields corresponding to the user from a database. The computer-implemented method further includes determining at least one data field from the plurality of data fields. The computer-implemented method further includes identifying a plurality of relevant data points associated with the at least one data field from one or more data repositories. The plurality of relevant data points are identified based, at least in part, on a relevance function. Furthermore, the computer-implemented method includes selecting a plurality of unrelated data points from the one or more data repositories. The plurality of unrelated data points is unassociated with the at least one data field. The computer-implemented method also includes generating one or more user authentication requests. The one or more user authentication requests are generated based, at least in part, on the plurality of relevant data points and the plurality of unrelated data points.

In another embodiment, a server system is disclosed. The server system includes a communication interface, a memory including executable instructions, and a processor communicably coupled to the communication interface and the memory. The processor is configured to cause the server system to at least access a user profile including a plurality of data fields corresponding to a user from a database. The server system is further caused to determine at least one data field from the plurality of data fields. The server system is further caused to identify a plurality of relevant data points associated with the at least one data field from one or more data repositories. The plurality of relevant data points is identified based, at least in part, on a relevance function. Furthermore, the server system is caused to select a plurality of unrelated data points from the one or more data repositories. The plurality of unrelated data points are unassociated with the at least one data field. The server system is also caused to generate one or more user authentication requests. The one or more user authentication requests are generated based, at least in part, on the plurality of relevant data points and the plurality of unrelated data points.

In another embodiment, a computer system is disclosed. The computer system includes a memory including executable instructions, and a processor configured to execute the instructions to cause the computer system, at least in part, to access a user profile including a plurality of data fields corresponding to a user from a database. The computer system is further caused to determine at least one data field from the plurality of data fields. Furthermore, the computer system is caused to identify a plurality of relevant data points associated with the at least one data field from one or more data repositories. The plurality of relevant data points are identified based, at least in part, on a relevance function. The computer system is also caused to select a plurality of unrelated data points from the one or more data repositories. The plurality of unrelated data points are unassociated with the at least one data field. Moreover, the server system is caused to generate one or more user authentication requests. The one or more user authentication requests are generated based, at least in part, on the plurality of relevant data points and the plurality of unrelated data points.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device, or a tool and instrumentalities disclosed herein. Moreover, those in the art will understand that the drawings are not to scale. Wherever possible, like elements have been indicated by identical numbers:

FIG. 1 illustrates an exemplary representation of an environment related to at least some embodiments of the present disclosure;

FIG. 2 is a simplified block diagram of a server system, in accordance with an embodiment of the present disclosure;

FIG. 3 is an exemplary block diagram of data communication flow between a server system and a user device, in accordance with an embodiment of the present disclosure;

FIGS. 4A-4B provide a data flow diagram representation for performing user authentication, in accordance with an embodiment of the present disclosure;

FIGS. 5A-5B provide a data flow diagram representation for performing user authentication, in accordance with another embodiment of the present disclosure;

FIG. 6 is a data flow diagram representation for configuring a user authentication application, in accordance with an embodiment of the present disclosure;

FIGS. 7A-7C, collectively, represent various graphical user interfaces (GUIs) rendered on the user device for displaying user authentication requests to the user, in accordance with various embodiments of the present disclosure;

FIG. 8 is a process flow chart of a computer-implemented method for performing user authentication, in accordance with an embodiment of the present disclosure; and

FIG. 9 is a simplified block diagram of an electronic device capable of implementing various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the terms “engagement channel” or “interaction channel” refer to a platform through which an engagement or an interaction between different parties such as a user and an entity (e.g., a business or a service provider) may take place. In various examples, the engagement channel supported by a user device may include a keyboard-based channel, a mouse-based channel, a touch-based channel, a Virtual Reality (VR) based channel, an Augmented Reality (AR) based channel, etc., among other suitable implementations of engagement channels.

The present disclosure provides a technical solution to one or more problems stated herein. In a typical scenario, authenticating the identity of a user by asking a series of security questions to the user may be erroneous due to various social engineering techniques such as phishing, pretexting, baiting, quid pro quo, tailgating, etc., that may be used by a malicious entity. Further, a genuine user may also fail to authenticate their identity in a scenario where they forget the original answer to their security question. The present invention solves this technical problem by providing a quick-to-complete method and systems for authenticating the identity of the user using one or more user-specific authentication challenge requests in a manner that is hard for a malicious entity to bypass while being more user-friendly. Further, the difficulty of the authentication process (or the user-specific authentication challenge requests) provided by the present disclosure is adjustable as per the needs of the business entity or service provider. In some scenarios, the degree of difficulty for the user-specific authentication challenge requests may also be fine-tuned by an ML or an AI model based on past user behavior. Furthermore, due to the user-specific nature of the user authentication process, the likelihood of the user forgetting the information being checked is highly unlikely, thereby improving the chances of successful identity validation by the genuine user significantly.

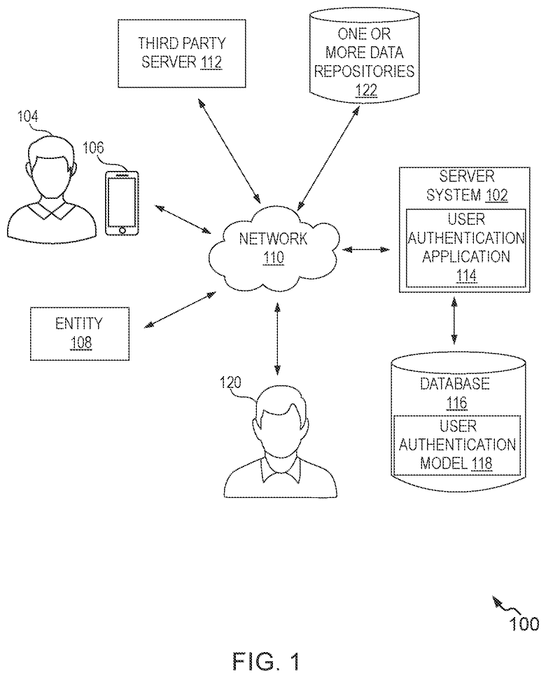

Various embodiments of the present invention are described hereinafter with reference to FIG. 1 to FIG. 9.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, generating user authentication requests for a user 104, receiving user authentication responses corresponding to the user authentication requests from the user 104, etc. The environment 100 generally includes a server system 102, a user device 106 associated with the user 104, an entity 108 offering products (e.g., goods, services, etc.) to the user 104, and a database 116, each coupled to, and in communication with (and/or with access to) a network 110. The network 110 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among the various entities illustrated in FIG. 1, or any combination thereof.

Various entities in the environment 100 may connect to the network 110 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, New Radio (NR) communication protocol, any future communication protocol, or any combination thereof. In some instances, the network 110 may include a secure protocol (e.g., Hypertext Transfer Protocol (HTTP), Secure Socket Lock (SSL)), and/or any other protocol, or set of protocols.

The user 104 may refer to a person/organization/entity that operates the user device 106 associated with the user 104. In some examples, the user device 106 may include any portable communication devices such as a smartphone, tablet, personal digital assistant (PDA), phablet, wearable device, smartwatch, laptop computer, an augmented reality (AR) headset, a virtual reality (VR) headset, and the like. In some other examples, the user device 106 may include any fixed communication device such as a desktop, mainframe computer, workstation, and the like. In one example, the user device 106 may be equipped with an application for communicating with the entity 108 over the network 110. In various non-limiting examples, the application may correspond to a web browser, an application associated with the entity 108, an application programming interface (API) associated with the entity 108, an API associated with the server system 102, and the like.

The entity 108 may refer to a separate legal entity with a primary function to perform business activities (for example, selling goods, products, and/or services in exchange for cash/currency). In an example, the entity 108 may refer to an established bank that provides various financial services (e.g., banking services, loans, financial products such as debit/credit payment cards, investment services, etc.) to the user 104. In various examples, the entity 108 may be any establishment serving people such as social media, entertainment websites, government enterprises, non-government organization (NGO) websites, internal portals associated with the user's workplace, etc. The entity 108 may have a physical establishment and/or even exist virtually in a web or metaverse space. The entity 108 may provide products (such as goods, services, etc.) to the user 104.

In one example, the user 104 may access the services/products provided by the entity 108 by logging in through a login portal associated with the website or API operated by the entity 108. In some scenarios, the login process may require the user 104 to produce a user identity (user ID) along with a secure password/pin/passcode to authenticate their identity. If the user 104 enters the correct information in the login portal, identity of the user 104 is successfully validated and the user 104 can then access the services/products provided by the entity 108. However, if the user 104 is unable to provide the correct information during the login portal due to any reason (e.g., the user 104 may have forgotten the credentials for the login portal), the entity 108 may authenticate the identity of the user 104 by performing a user authentication process by performing one or more user-specific authentication challenges or authentication challenge requests.

In an example, the user authentication process is carried out by the server system 102. In another example, the user authentication process may be done by other servers associated with the entity 108. It should be noted that, while the present disclosure describes the method and systems for authenticating the identity of the user 104 by the server system 102, the various techniques that are described by the present disclosure can be implemented by another entity as well such as, but not limited to, an entity server (not shown in figures) associated with the entity 108, a third party server 112 associated with a third-party service provider, or a cloud-based server.

In an embodiment, the server system 102 runs an instance of a user authentication application 114 or user authentication service (referred, interchangeably hereafter). In one embodiment, the server system 102 utilizes a user authentication model 118 stored in the database 116 to run the user authentication application 114. It should be understood that the user authentication model 118 may include various hardware-run artificial intelligence models or machine learning models. The server system 102 should be understood to be embodied in at least one computing device in communication with the network 110, which may be specifically configured, via executable instructions, to perform as described herein, and/or to be embodied in at least one non-transitory computer-readable media. In one embodiment, the user authentication application 114 is an application/tool resting at the server system 102.

In one implementation, the server system 102 includes one or more databases, such as the database 116. The database 116 may be configured to store the user authentication model 118 among other relevant data associated with the server system 102. It should be understood that the user authentication model 118 may also refer to one or more artificial intelligence (AI) based models and/or machine learning (ML) based models that are configured to perform a user authentication process. In an embodiment, the user authentication model 118 may refer to an application or an instance of an application that may run on the server system 102. In one embodiment, the user authentication application 114 performs the user authentication process based on the implementation of the user authentication model 118. In alternative embodiments, the user authentication model 118 may be configured to perform the user authentication process based on various known analysis techniques such as database lookup, database mapping, heuristic functions, etc., among other suitable analysis techniques.

In an embodiment, the user authentication application 114 may be or include a web browser that the user 104 may use to authenticate their identity to access the service provided by the entity 108. In some examples, the user device 106 is communicably coupled with the server system 102 through the network 110 and the user device 106 is capable of interacting with the user authentication application 114 associated with the server system 102 through a web browser or an API installed on the user device 106. In such scenarios, the user authentication application 114 may include a mobile application or “app”. In various non-limiting examples, the user authentication application 114 may be artificial intelligence (AI)/machine learning (ML)/deep learning (DL) based application installed and accessed in an Android®-based smartphone, an iOS®-based iPhone®, iPadOS®-based iPad®, a Windows®-based computer, a macOS®-based computer, an augmented reality (AR) device, a virtual reality (VR) device, and the like. The user authentication application 114 may include a “plug-in” or an “extension” to another application, such as a pre-existing application or API associated with the entity 108.

In an implementation, the user authentication application 114 is managed, hosted, or executed by the server system 102. In another implementation, the user authentication application 114 is managed, hosted, or executed by a communication device (not shown in figures) associated with the server system 102 or the entity 108. The user authentication application 114 is configured to generate one or more user-specific authentication challenge requests to perform authentication of the user 104.

In one implementation, the user authentication application 114 is configured to display various graphical user interfaces (GUIs) to an administrator 120 for managing or configuring the operating parameters such as threshold time period, decision score (explained later in the present disclosure), and the like of the user authentication application 114. The administrator 120 may refer to any person authorized to operate the user authentication application 114. In an example, the administrator 120 is responsible for the maintenance or upkeep of the user authentication application 114 or the server system 102. In another example, the administrator 120 is responsible for troubleshooting of the user authentication application 114. In yet another example, the administrator 120 is responsible for the secure handling of data associated with the user authentication application 114.

In an embodiment, the user authentication application 114 associated with the server system 102 is configured to perform one or more of the operations described herein. The user authentication application 114 associated with the server system 102 accesses a user profile associated with the user 104 from the database 116. The user profile includes a plurality of data fields related corresponding to the user 104. In various non-limiting examples, the plurality of data fields may include location data points (such as the user's residential address), auditory data points (such as the user's voice signature), video data points (such as videos associated with the user 104), user demographic data points or user data points (such as date of birth, place of birth, contact details, etc.), and user behavior data points (such as data related to observed behavior patterns of the user 104, purchase behavior, activity-related data, etc.). In one example, the user 104 can manually generate the user profile. More specifically, the user 104 can manually define the plurality of data fields (e.g., known addresses, voice signatures, demographic information, etc.) to be used further to generate the user authentication challenge requests.

The user authentication application 114 is then configured to determine at least one data field from the plurality of data fields. The at least one data field is determined based on the suitability of the particular data field for the identification of the user 104. It is noted that some data fields are more suitable than other data fields for the generation of the user-specific authentication challenge requests for the user 104. The user authentication application 114 may utilize the user authentication model 118 to determine the suitability of the data field. Further, the user authentication application 114 identifies a plurality of relevant data points associated with the specific data field. The plurality of relevant data points is identified based, at least in part, on a relevance function. In another embodiment, the administrator 120 may manually select the at least one data field. In yet another embodiment, during generation of the user profile of the user 104, the user 104 may manually define the at least one data field to be used for generation of the one or more user-specific authentication challenge requests.

Once the plurality of relevant data points is identified, the user authentication application 114 may select additional data related to the plurality of relevant data points. The additional data may include, for example, images/videos of the location coordinates of the data points, audio associated with the relevant data points, and the like. In various example scenarios, where the data type of the at least one data field is textual (e.g., user profile data, user behavior data, demographic user data, and the like), the relevant data is obtained by extracting features from the at least one data field.

The user authentication application 114 selects the plurality of unrelated data points from one or more data repositories 122. The plurality of unrelated data points is unassociated with the at least one data field. In an example, the plurality of unrelated data points may be selected randomly. In one example, if the at least one data field is selected as a summary of the user 104, the user authentication application 114 identifies the plurality of relevant data points based on the summary of the user 104. The user authentication application 114 may then utilize this summary to find or generate the related information based on the execution of the user authentication model 118. It is to be understood that by having a model trained on a corpus of information about different topics, an automatic question-answering AI may be used to generate questions about the topics, etc. identified in the data points. The user authentication application 114 may then classify these data points into relevant data points (i.e., correct answers for the questions) and unrelated data points (i.e., incorrect answers for the questions).

Further, the user authentication application 114 generates one or more user authentication requests. In various non-limiting examples, the one or more user authentication requests may include authentication challenges (e.g., visual challenges, auditory challenges, etc.) for the user 104 to attempt, and successfully authenticate themselves. In other examples, the user authentication challenges may be generated in the form of a game, to improve user experience and reduce user frustrations while attempting the user authentication requests.

In an embodiment, the user authentication application 114 provides a user interface (UI) on the user device 106 to allow the user 104 to generate the user profile. More specifically, the user 104 may manually define the at least one data field (e.g., a known address, etc.) to be used for the generation of one or more user-specific authentication challenge requests. Initially, the user authentication application 114 determines a plurality of relevant images (i.e., relevant data points) based on the manually defined known address of the user 104 in the user profile. In an example, the plurality of relevant images may belong to locations nearby to the manually defined known address of the user 104. Then, the user 104 may select one or more images that are recognizable by the user 104 from the plurality of relevant images. The user authentication application 114 then stores the selected one or more images as the one or more relevant data points in the user profile.

In one implementation, to initiate user authentication process, the user authentication application 114 selects the plurality of relevant data points (i.e., the images already stored in the user profile) and a plurality of unrelated data points from the one or more data repositories 122 to generate the one or more user authentication requests. It is noted that by combining the unrelated data points with the known relevant data points, the accuracy of the user authentication process is improved.

In one implementation, the user authentication application 114 utilizes communication application programming interfaces (APIs) to communicate back and forth with the user device 106. In an example, the user authentication application 114 utilizes various distribution methods for sharing the one or more user authentication requests with the user 104. The distribution methods may include short message service (SMS), electronic mail (email), communication APIs, embeddable widgets, and the like. In an example, the user authentication application 114 utilizes communication APIs to share results of the user authentication process with the user 104 and the entity 108. Generally, “API” refers to a set of programming standards and/or instructions for web-based applications and tools. For instance, “communication APIs” refer to APIs specifically designed to enable communication (e.g., voice calls, e-mail functionality, third-party messaging functionality, other communication functionality, etc.).

The number and arrangement of systems, devices, and/or networks shown in FIG. 1 are provided as an example. There may be additional systems, devices, and/or networks; fewer systems, devices, and/or networks; different systems, devices, and/or networks, and/or differently arranged systems, devices, and/or networks than those shown in FIG. 1. Furthermore, two or more systems or devices are shown in FIG. 1 may be implemented within a single system or device, or a single system or device or they may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

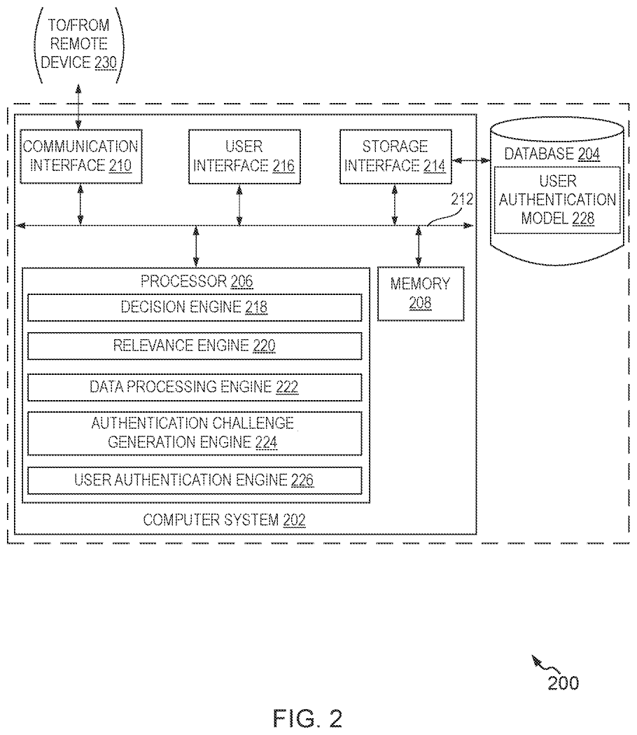

FIG. 2 is a simplified block diagram of a server system 200, in accordance with one embodiment of the present disclosure. Examples of the server system 200 include, but are not limited to, the server system 102 as shown in FIG. 1. In some embodiments, the server system 200 is embodied as a cloud-based and/or SaaS-based (software as a service) architecture.

The server system 200 includes a computer system 202 and a database 204. The computer system 202 includes at least one processor 206 for executing instructions, a memory 208, a communication interface 210, a storage interface 214, and a user interface 216. The one or more components of the computer system 202 communicate with each other via a bus 212. The components of the server system 200 provided herein may not be exhaustive and the server system 200 may include more or fewer components than those depicted in FIG. 2. Further, two or more components depicted in FIG. 2 may be embodied in one single component, and/or one component may be configured using multiple sub-components to achieve the desired functionalities.

In one embodiment, the database 204 is integrated within the computer system 202 and configured to store an instance of the user authentication application 114 and one or more components of the user authentication application 114. The one or more components of the user authentication application 114 may include, but are not limited to, the user authentication model 228 associated with the user authentication application 114, and the like. The computer system 202 may include one or more hard disk drives or solid-state drives as the database 204. The storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The processor 206 includes suitable logic, circuitry, and/or interfaces to execute computer-readable instructions for performing the user authentication process in real time. Examples of the processor 206 may include, but are not limited to, an application-specific integrated circuit (ASIC) processor, a graphical processing unit (GPU), a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), a solid-state drive (SSD), and the like. It will be apparent to a person skilled in the art that the scope of the disclosure is not limited to realizing the memory 208 in the server system 200, as described herein. In some embodiments, the memory 208 may be realized in the form of a database server or a cloud storage working in conjunction with the server system 200, without deviating from the scope of the present disclosure.

The processor 206 is operatively coupled to the communication interface 210 such that the processor 206 is capable of communicating to/from remote device 230 such as a communication device associated with the server system 200, or with any entity 108 connected to the network 110 (e.g., as shown in FIG. 1). In one embodiment, the processor 206 is configured to invoke the user authentication application 114 that further performs the user authentication process to verify the identity of the user 104. The database 204 further includes the user authentication model 228 associated with the user authentication application 114. It should be noted that the user authentication model 228 is identical to the user authentication model 118 described in reference to FIG. 1.

It should be noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2. It should be noted that the server system 200 is identical to the server system 102 described in reference to FIG. 1.

In one embodiment, the processor 206 includes a decision engine 218, a relevance engine 220, a data processing engine 222, an authentication challenge generation engine 224, and a user authentication engine 226. It should be noted that the components, described herein, can be configured in a variety of ways, including electronic circuitries, digital arithmetic and logic blocks, and memory systems in combination with software, firmware, and embedded technologies.

In one embodiment, the decision engine 218 includes suitable logic and/or interfaces for accessing a user profile corresponding to the user 104 from a database (e.g., the database 116 of FIG. 1). In one implementation, the user profile is accessed from a verified and known source including, for example, a secure database maintained and operated by the entity 108 or the server system 200. For example, a bank may maintain a secure database of its customers (i.e., the user 104). The user profile includes a plurality of data fields related to the user 104. In various non-limiting examples, the data fields may include location data (such as the user's address), auditory data (such as the user's voice signature), video data (such as videos associated with the user 104), user data (such as date of birth, place of birth, etc.), user behavior data (such as data related to observed behavior patterns from the user 104, purchase behavior, activity-related data, etc.), and demographic user information (such as user ID, user profile data, user's hobbies, user's interests, social media data, etc.).

It is to be noted that the data associated with the plurality of data fields may be collected by the entity 108 or the server system 200 during the onboarding of the user 104 or during the association of the user 104 with the entity 108 over a time period from various sources (e.g., the one or more data repositories 122 of FIG. 1). In an embodiment, the plurality of data fields corresponding to the user 104 may be collected from the one or more data repositories 122. The one or more data repositories 122 may include, but not be limited to, user's social media, data aggregators, publicly available databases, and government census data. In some scenarios, the user profile data may be verified by the entity 108 or the server system 200 through a plurality of known verification techniques such as ID card verification, document verification (such as utility bills as a residence proof, and the like), biometric verification, and questionnaires, etc., among other suitable verification techniques before being added to their secure database (e.g., the database of FIG. 1). In an embodiment, the user profile may also get updated based, at least in part, on the plurality of data fields. In an example, the plurality of data fields may be periodically updated either on-demand (either by the entity 108 or the administrator 120) or at regular time intervals to keep the user profile accurate and updated.

The decision engine 218 is further configured to determine or classify at least one data field from the plurality of data fields via the implementation of a machine learning model (e.g., the user authentication model 118 of FIG. 1). It should be noted that the at least one data field corresponds to a valid or known data field of the user 104 such as an address, audio file, demographics, and the like. The at least one data field is identified based on the suitability of the data field for the identification of the user 104. It is to be understood that some data fields are more suitable for being used to generate user-specific authentication challenge requests (hereinafter referred to as ‘user authentication requests’ or ‘user authentication challenges’) for determining the identity of the user 104. The suitability of the at least one data field can be determined using the user authentication model 228. In an example, the user authentication model is trained using a large dataset of identification results received from a plurality of test users in response to simulated user authentication challenge requests generated using the plurality of data fields.

In some exemplary scenarios, the AI or ML models can be incrementally trained as well using the identification results from the various authentication challenges conducted by the user authentication application 114 associated with the server system 200 during its operation by the entity 108 to authenticate the identity of the user 104. Further, the user authentication model 228 including the trained ML or AI models may be configured to self-authenticate and check for the requirement of incremental training to produce high accuracy in suitable data field classification from the plurality of data fields. In an alternative embodiment, the user authentication model 228 may implement the determination/classification of the plurality of data fields using other analysis techniques such as a heuristic function instead of relying solely on the ML or AI models as well. Further, the decision engine 218 transmits the at least data field to the relevance engine 220. In some implementations, the administrator 120 or the user 104 can manually select the at least one data field.

The relevance engine 220 includes suitable logic and/or interfaces for identifying a plurality of relevant data points associated with the at least one data field from the one or more data repositories 122. The relevance engine 220 is configured to identify the plurality of relevant data points based, at least in part, on a relevance function.

In one implementation, the relevance engine 220 is initially configured to determine a data type of the at least one data field. The relevance engine 220 is configured to access one or more data points associated with the at least one data field from the one or more data repositories 122 based at least on the determined data type of the at least one data field. Additionally, the relevance engine 220 is configured to assign relevance scores to the one or more data points based, at least in part, on the machine learning model. Each relevance score is assigned to each data point of the one or more data points.

Further, the relevance engine 220 is configured to select the plurality of relevant data points based, at least in part, on the relevance scores. The term “relevance score” herein represents a score assigned to a data point based on the degree of association between two distinct data points. In other words, it represents the degree of association between each data point of the one or more data points accessed by the relevance engine 220 and the at least one data field. In one embodiment, the relevance score for each data point is determined based on the user authentication model 228 (i.e., the machine learning model) that is trained to assess the relation and relevance between two distinct data points.

In an embodiment, a relevance threshold score may be pre-defined by the server system 200 such that only data points with relevance scores higher than the relevance threshold score may be selected as the plurality of relevant data points. This relevance threshold score may be static/predefined or dynamic in nature based on the requirements of the entity 108 conducting the identity validation. For example, the relevance score may be adjusted or fine-tuned based on the requirements of the entity 108 by the user authentication model 228. In another example, the relevance threshold score may be predefined by the administrator 120.

In one example, if location data, i.e., the user's address is identified as the at least one data field, then data points such as GPS coordinates associated with the user's addresses in the near vicinity of the user's address are considered to have high relevance and are therefore assigned a higher relevance score by the server system 200 and alternatively, data points associated with addresses far from the vicinity of the user's address are considered to have low relevance and are therefore assigned a lower relevance score. In one example, the relevance may be calculated based on the actual distance between the address of the data point and the address of the user 104. In various examples, the user authentication model 228 may be used to determine the relevance between the data point and the suitable data points based on a plurality of user-specific factors such as the route followed by the user 104 daily while traveling from their home address to their work address and vice versa. In such a scenario, the data points related to addresses that lie on or near the route followed by the user 104 may have a higher relevance score than, a data point associated with an address or location that is within 1 km from the user's home address.

In yet another example, if auditory data, i.e., the audio data (such as in the form of a voice signature and the like) is identified as the at least one data field, then data points such as audio clips associated with audio files similar to the pitch and tone among other various audio features of the user 104 are considered to have high relevance and are therefore assigned a higher relevance score by the server system 200 and alternatively, data points associated with pitch and tone among other various audio features that are very different from the pitch and tone among other various audio features of the user 104 are considered to have low relevance and are therefore assigned a lower relevance score. In one example, the relevance may be calculated based on the actual difference between the pitch and tone among other various audio features associated with the user's audio data. In one example, user authentication model 228 may be used to determine the relevance between the data point and the suitable data points.

In an embodiment, the one or more relevant data points are accessed from a data repository such as an internal database or a third-party server 112 or service provider. For example, GPS coordinates of various locations/addresses may be received from an API associated with Google Places®, Google Street View®, Apple Maps®, Apple look Around®, MapMyIndia®, CycloMedia®, etc., among other suitable service providers. In various example, different audio signatures may be received from an API associated with audio signal aggregators. Further, in some examples, when the hobbies of the user 104 are used as the suitable data point, the relevant data point may be accessed from websites associated with the hobby of the user (e.g., sports related-websites, hobby blogs, public databases, etc., among other suitable sources).

Once the plurality of relevant data points is accessed, the relevance engine 220 may further access additional data related to the plurality of relevant data points such as, but not limited to, images/videos of the location coordinates of the data points, and audio associated with relevant data points, etc. and the like. In various example scenarios, where the data type of the at least one data field is either text, user profile data, user behavior data, or general user data, the relevant data is obtained by extracting features from the suitable data point. Further, the relevance engine 220 transmits the one or more relevant data points to the data processing engine 222.

Furthermore, the relevance function may be used to fine-tune or filter the one or more relevant data points determined previously to select one or more valid data points from the one or more relevant data points based on at least in part on, user authentication model 228. In one embodiment, the user authentication model 228 may determine the one or more valid data points based at least in part, on their probability of identification by the user 104 during the user authentication challenge process. In an embodiment, the user authentication model 228 may determine the likelihood of the relevant data point being recognized by the user 104.

In an embodiment, the user authentication model 228 may determine the probability of the relevant data point being recognized by the user 104, i.e., a data point with a high probability (such as but not limited to higher than 90%) of being identified by the specific user being tested is selected as a valid data point by the data processing engine 222. In an embodiment, the user authentication model 228 may be used by the data processing engine 222 to determine the probability of identification. For example, an image associated with an address with high relevance score displaying a street is unlikely to be detected by the user 104 whereas an image associated with an address displaying a STOP sign on the user's daily route to their workplace with high relevance score is highly likely to be recognized by the user 104. Similarly, in another example, the difference between an audio clip with high loudness from the user's voice is less likely to be recognized by the user 104 whereas an audio clip with a different pitch than the user's voice can be easily recognized by the user 104 performing the user-specific authentication challenge. These one or more valid data points may then be set as the plurality of relevant data points. The plurality of relevant data points is then shared with the authentication challenge generation engine 224 by the relevance engine 220.

In an embodiment, the data processing engine 222 includes suitable logic and/or interfaces for selecting a plurality of unrelated data points unassociated with the at least one data field from the one or more data repositories 122. In one implementation, the plurality of unrelated data points may be randomly selected from data points remaining after the selection of the plurality of relevant data points from the one or more data repositories 122. In another implementation, the plurality of unrelated data points may be randomly selected from the data points with a low relevance score. In yet another implementation, the plurality of unrelated data points may be selected from the one or more data points based on a low probability of identification by the user 104. For example, a road intersection that is 20 km away from the user's house is less likely to be recognized by the user 104. The plurality of unrelated data points is then shared with the authentication challenge generation engine 224 by the data processing engine 222.

In one embodiment, the authentication challenge generation engine 224 generates one or more user authentication requests for the user 104 based on the plurality of relevant data points and the plurality of unrelated data points. In one implementation, the authentication challenge generation engine 224 generates the one or more user authentication requests for the user 104 based at least on an engagement channel supported by the user device 106. In one example, images associated with the plurality of relevant data points and the plurality of unrelated data points are displayed to the user 104. The user 104 may identify and select the plurality of relevant data points to confirm their identity. In one implementation, the authentication challenge generation engine 224 is configured to determine the device type of the user device 106 before determining a pre-defined user interface (UI) for the generation or rendering of the one or more user authentication requests based, at least in part, on the identified device type of the user 104. Further, the one or more user authentication requests are adapted based, at least in part, on the determined pre-defined UI, thereby ensuring a smooth and consistent user experience. For example, when the engagement channel between the user 104 and the entity/server system 200 is a VR device, then the UI of the user authentication request is designed based on a VR-based user interface. In one non-limiting example, the authentication challenge generation engine 224 may use DHCP fingerprinting to determine the device type of the user device 106.

In one example, if the authentication challenge generation engine 224 determines the user device 106 as a VR device, then, the authentication challenge generation engine 224 may stitch a plurality of images associated with the plurality of relevant data points and the plurality of unrelated data points to generate a panoramic view. It is to be noted that images in the surroundings of a relevant or unrelated data point may be first, accessed from the external service provider and then, stitched together to generate an interactive panorama environment for the user 104 operating the VR device.

In an embodiment, the authentication challenge generation engine 224 utilizes communication application programming interfaces (APIs) to communicate back and forth with the user device 106. The authentication challenge generation engine 224 may also enforce a time limit to complete or respond to each user authentication request. This time limit or threshold time period may be determined by the authentication challenge generation engine 224 based, at least in part, on various security factors including, for example, the difficulty of identification of a particular user authentication challenge, time that a malicious entity may take to search or obtain the correct answer maliciously, etc., among other suitable security factors. In an example, the time limit or a threshold time period may be determined based on the at least one data field by the user authentication model 228. Therefore, each of the one or more user authentication requests is valid for a pre-defined time interval.

This is done because some data points can be harder for the user 104 to recognize than others. For example, a location-related authentication challenge is generally easier for the user 104 to complete than an audio-related authentication challenge. Therefore, the time interval or the threshold time period established by the authentication challenge generation engine 224 is also user-specific in nature as well thus, it reduces the likelihood of a malicious entity gaining access to the correct answers within the threshold time period thereby, reducing the security risk. Further, the authentication challenge generation engine 224 may display the one or more user authentication requests on a graphical user interface (GUI) rendered on the user device 106 of the user 104.

In one embodiment, the user authentication engine 226 includes suitable logic and/or interfaces for receiving one or more user responses from the user 104. The user 104 may provide the one or more user responses as a response to the one or more user authentication requests. The user responses may be received as a keyboard input, mouse input, and the like. Further, the user authentication engine 226 determines a threshold decision score (hereafter referred to as the ‘decision threshold’) based on the at least one data field determined by the decision engine 218 of the server system 200 to generate the one or more authentication challenge requests, i.e., the value of the decision threshold value is dynamic in nature. However, in some implementations, the decision threshold value may be predefined or static as well based on the requirements of the entity 108 or the administrator 120.

For example, when the at least one data field is location data, the decision threshold value may be set to a higher value than when the at least one data field is user profile data since the user profile data such as hobbies may not be regularly updated. In some scenarios, the user 104 may not even be updated with trivia related to their hobbies such as sports, thereby the chances of the user 104 selecting a correct option during the user profile-based authentication challenge may be lower than the location-based authentication challenge. Therefore, the decision threshold value can be adapted to accommodate such variance in the likelihood of receiving correct answers from the user 104. In some examples, the decision threshold value is adapted or fine-tuned using user authentication model 228 including one or more machine learning models. The model may be trained based on past user response data to determine or predict the likelihood of receiving the correct response from the user 104 in response to an authentication challenge generated using a particular at least one data field.

Further, the user authentication engine 226 determines if each user response from the set of user responses received from the user 104 in response to the one or more user-specific authentication challenge requests is correct or incorrect. Based on these user responses being correct or incorrect, the user authentication engine 226 computes or calculates a decision score. In a scenario, where the computed decision score is equal to or higher than the decision threshold value, the user authentication engine 226 authenticates the identity of the user 104. In an alternative scenario, if the computed decision score is lower than the decision threshold value, the user authentication engine 226 invalidates the identity of the user 104. Therefore, the calculated decision score is compared with the pre-determined threshold decision score to determine whether to authenticate the user 104 as a genuine user or identify or invalidate the user 104 as a non-genuine user.

For example, if number of the user-specific authentication challenge requests is ‘X’ (where ‘X’ is a natural number), then the user 104 has to answer all of the ‘X’ number of authentication challenge requests correctly to achieve a perfect decision score. However, if the user 104 fails to correctly answer any authentication challenge request, then the decision score is reduced.

In this scenario, in an embodiment, an additional authentication challenge request may be provided to the user 104 by the authentication challenge generation engine 224. This may be achieved by the user authentication engine 226 transmitting a request to the authentication challenge generation engine 224 to generate a new authentication challenge request. In another embodiment, the user 104 may choose to configure the server system 200 to introduce an additional authentication challenge request to provide the user 104 with an opportunity to increase their decision score. In one example, this ability to provide additional authentication challenge requests may also be enabled by the entity 108 or the administrator 120. This provides a ‘buffer’ or ‘margin of error’ that can be factored into the decision score. The user authentication engine 226 may also determine the decision threshold value depending on the use case (and what's at stake) or the entity 108. For example, if the user authentication process is for the user 104 associated with the entity 108 providing financial services, then the decision threshold value can be kept high by the user authentication engine 226 however, if the entity 108 is a blogging website, then the decision threshold value may be lowered.

In another embodiment, the server system 200 may also calculate the probability of the user 104 being the valid user. In an example, a probability of the user being a genuine user may be calculated based on the user 104 recognizing ‘X’ number of places that are ‘Y’ distances from an address of the user 104. Here, ‘X’ and ‘Y’ are natural numbers such that X≥Y.

In particular, it should be noted that the present identity validation technique provides a technical advantage over the conventional validation techniques that only compare the user response against a database including predefined correct answers, therefore such systems are only capable of binary outcomes however, the validation technique provided by the present disclosure goes beyond the convention techniques and provides a probability regarding the user's identity being genuine, based on this probability that the server system 200 or entity 108 may determine whether to authenticate the user 104 or not based on the service being provided by the entity 108. In an alternative embodiment, even if the decision score is greater than the decision threshold value, the user authentication engine 226 may still invalidate the identity of the user 104 if the probability of the user 104 being the valid user is less than a predefined threshold determined based on the type of service provided by the entity 108, e.g., if the probability is 80%, however, when the service being provided is related to high-value financial products, then the server system 200 may set the minimum probability to 90% and still invalidate the identity of the user 104.

In another embodiment, the user authentication engine 226 may also monitor cookies associated with the user 104 to determine if there are multiple validation re-attempts by the user 104 and it may block the authentication challenge upon detecting multiple-reattempts from the user 104 to reduce security risks. In yet another embodiment, the user authentication engine 226 may also capture an Internet Protocol (IP) address and/or a media access control (mac) address associated with the user device 106 of the user 104 attempting the challenge to block multiple attempts from the same IP or MAC address detected by the user authentication engine 226 to reduce security risks. In yet another embodiment, the user authentication engine 226 may analyze user 104 behavior to determine a security risk associated with the user 104 attempting the authentication challenge and block or stop the authentication challenge if any security risk is detected.

For example, the server system 200 may track user 104 activity while the user 104 is interacting with the user interface generated by the authentication challenge generation engine 224. Further, the server system 200 may determine if the user 104 session has ‘lost focus’, i.e., the user 104 has moved to a different tab on the web-browser, the user 104 has switched between applications, or the user 104 has stopped interacting with the user interface for an extended period of time, etc., among other suitable activities. As may be understood, such activities may suggest that the user 104 is consulting external data sources to attempt the user-specific authentication challenge requests. Therefore, since such activities pose a security risk, the user authentication engine 226 may suspend the authentication challenge request or invalidate the identity of the user 104.

Therefore, it should be understood that the server system 200 may authenticate the identity of the user 104 if the decision score is equal to or greater than the decision threshold value. Alternatively, the server system 200 invalidates the identity of the user 104 if the decision score is less than the threshold value. Since the decision threshold may be dynamic in nature based on the at least one data field, the server system 200 provides dynamic and adaptive authentication capabilities for authentication of the identity of the user 104.

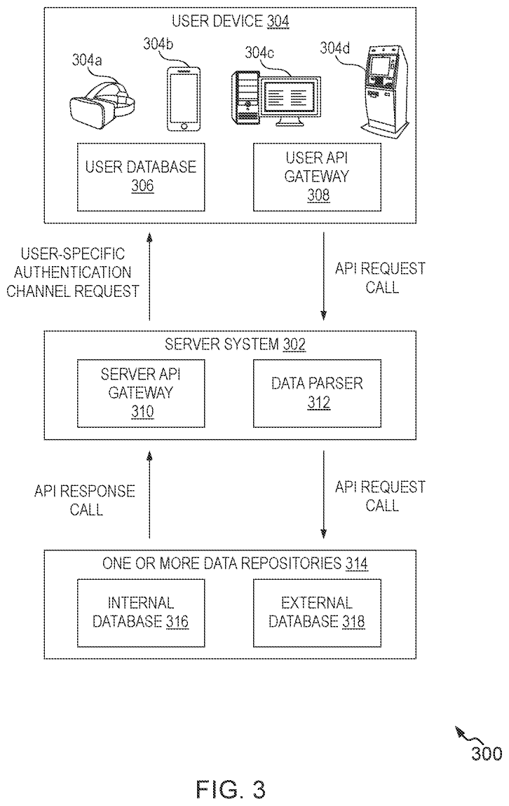

FIG. 3 is an exemplary block diagram 300 of data communication flow between a server system 302 and a user device 304, in accordance with an embodiment of the present disclosure.

As explained above, a user device 304 may communicate with the server system 302 via a user API gateway 308. The user device 304 is identical to the user device 106 of FIG. 1. In an example, the user device 304 may further include a user database 306. In various non-limiting examples, the user device 304 may correspond to a VR headset 304a, a mobile device 304b, a desktop computer 304c, a kiosk 304d, and other similar communication devices. In one implementation, the user database 306 may include information associated with the user device 304 of the user 104. In various non-limiting examples, the user database 306 may include device configuration data, metadata, user profile data, and the like. In one non-limiting example, the user database 306 may be implemented using a memory. Some non-limiting examples of the memory may include a random-access memory (RAM), a read-only memory (ROM), a removable storage drive, a hard disk drive (HDD), a solid-state drive (SSD), and the like. In some other examples, the memory may be realized in the form of a cloud storage working in conjunction with the user device 304, without deviating from the scope of the present disclosure.

In an example, an instance of the user authentication application 114 may communicate with the server system 302 via the user API gateway 308. In one example, the user API gateway 308 enables the user device 304 to implement a set of programming standards to share instructions and/or requests with the server system 302. In some examples, the user API gateway 308 may facilitate communication such as sending a request to initiate communication with the server system 302, receiving user-specific authentication challenge requests from the server system 302, transmitting user responses in response to the authentication challenge requests to the server system 302, etc., among other communication between the user device 304 and the server system 302. In one example, the communication between the user device 304 and the server system 302 may be implemented through various API calls between the user API gateway 308 and the server API gateway 310.

In one implementation, the server system 302 includes a data parser 312. In addition, a server API gateway 310 enables the server system 302 to implement a set of programming standards to share instructions and/or requests with the user device 304. More specifically, the user API gateway 308 of the user device 304 uses API calls to connect with the server API gateway 310 of the server system 302. In one implementation, the user authentication application 114 may communicate with the user device 304 via the server API gateway 310. In some examples, the server API gateway 310 may facilitate communication such as receiving a request to initiate communication from the user device 304, transmitting user-specific authentication challenge requests to the user device 304, receiving authentication challenge responses in response to the authentication challenge requests from the user device 304, etc., among other communication between the server system 302 and the user device 304.

In one implementation, the data parser 312 collects and processes various forms of data inputs to generate the user-specific authentication challenge requests. In an example, the data parser 312 may communicate with one or more data repositories 314 to collect various data fields or data points required to generate the user-specific authentication challenge requests. The one or more data repositories 314 are identical to the one or more data repositories 112 of FIG. 1. In one example, the one or more data repositories 314 may include the plurality of relevant data points and the plurality of unrelated data points. In an example, initially, the data parser 312 may receive the user profile from the database 116 of FIG. 1. Further, the data parser 312 accesses the plurality of relevant data points and the plurality of unrelated data points from the database 116. Furthermore, the data parser 312 generates the one or more user-specific authentication challenge requests by compiling the plurality of relevant data points and the plurality of unrelated data points. In some non-limiting examples, the database may include known or internal trusted databases 316 and/or third-party external databases 318 associated with third-party servers 112.

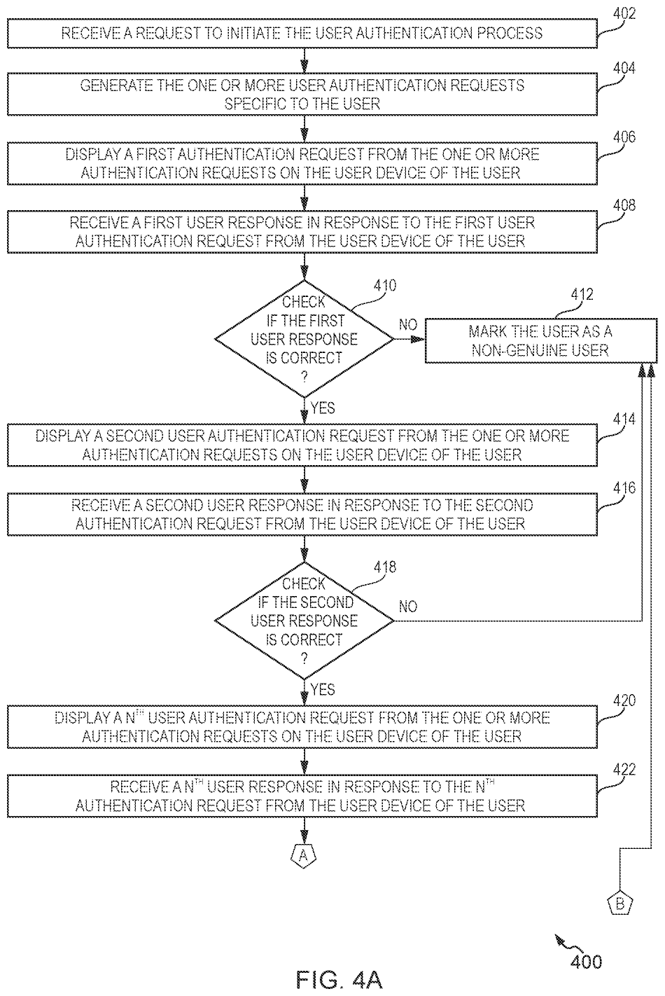

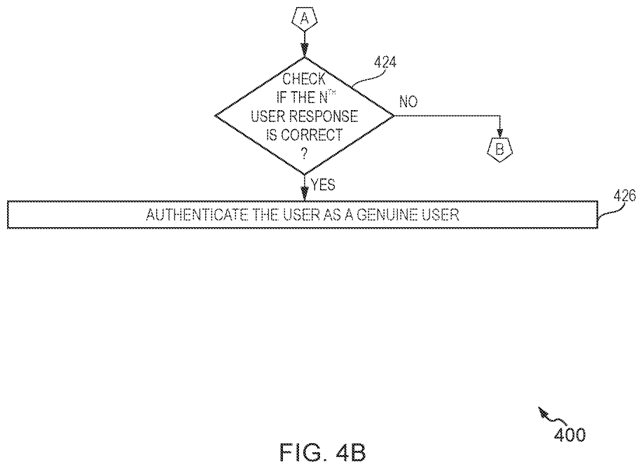

FIGS. 4A-4B, collectively, provide a data flow diagram representation 400 for performing user authentication, in accordance with an embodiment of the present disclosure. The sequence of operations of the representation 400 may not be necessarily executed in the same order as they are presented. Further, one or more operations may be grouped together and performed in form of a single step, or one operation may have several sub-steps that may be performed in parallel or in a sequential manner. It is to be noted that to explain the process steps of FIGS. 4A-4B, references may be made to system elements of FIG. 1 and FIG. 2.

At 402, the server system 200 receives a request to initiate the user authentication process. In one example, the request to initiate the user authentication process may be received from a customer (e.g., the user 104) who is unable to log in inside his/her account associated with the entity 108. In some non-limiting examples, the request to initiate the user authentication process may be received via a secure protocol such as a Hypertext Transfer Protocol (HTTP), a Secure Socket Lock (SSL), and the like.

At 404, the server system 200 generates the one or more user authentication requests specific to the user 104. It is to be noted that each of the one or more user authentication requests is different than the other user authentication requests. In addition, the server system 200 may generate ‘n’ number of the one or more user authentication requests based on the user 104, where ‘n’ is a natural number. A detailed explanation of the generation of the one or more user authentication requests has been provided in detail with reference to FIG. 2, and therefore, it is not reiterated for the sake of brevity. It is noted that the server system 200 determines the number of user authentication requests to be issued to the user 104 such that the number ‘n’ is appropriate to reasonably authenticate the identity of the user 104 with a high probability. In an example, the server system 200 may generate five user authentication requests for a user 104 A. In another example, the server system 200 may generate seven user authentication requests for a user 104 B, and so on.

At 406, the server system 200 displays a first user authentication request from the one or more authentication requests on the user device 106 of the user 104. In some non-limiting examples, the server system 200 may display the one or more user authentication requests on the user device 106 via engagement channels including, for example, electronic mail (e-mail), short message service (SMS), and the like.

At 408, the server system 200 receives a first user response in response to the first user authentication request from the user device 106 of the user 104. In some non-limiting examples, the user 104 may provide the first user response via mouse click, keyboard entry, touch-based input, gesture input (in case of AR/VR devices, etc.), and the like. In an example, the user 104 may provide a user authentication response as ‘YES’ to a user authentication request by nodding their head vertically in response to viewing an image that is relevant to the user 104, if the user authentication request is received on an AR/VR device. In another example, the user 104 may provide a user authentication response as ‘NO’ to a user authentication request by nodding their head horizontally in response to viewing an image that is not relevant to the user 104, if the user authentication request is received on an AR/VR device.

At 410, the server system 200 checks whether the first user response submitted by the user 104 as a response to the first user authentication request is correct. In one example, the user authentication engine 226 may check whether the first user response submitted by the user 104 is correct.

If the first user response submitted by the user 104 is incorrect, the server system 200 marks the user 104 as a non-genuine user, i.e., the user 104 is invalidated, at 412. In addition, the server system 200 may block the access of the user 104. For example, the server system 200 may not allow the user 104 to access the website associated with the entity.

Otherwise, at 414, the server system 200 displays a second user authentication request from the one or more authentication requests on the user device 106 of the user 104.

At 416, the server system 200 receives a second user response in response to the second user authentication request from the user device 106 of the user 104.

At 418, the server system 200 checks whether the second user response submitted by the user 104 as a response to the second user authentication request is correct. In one example, the user authentication engine 226 may check whether the second user response submitted by the user 104 is correct.

If the second user response submitted by the user 104 is incorrect, the server system 200 marks the user 104 as a non-genuine user 104, i.e., the user 104 is invalidated, at 412.

Otherwise, at 420, if the second user response submitted by the user 104 is correct, then the server system 200 displays n^{th} user authentication request from the one or more authentication requests on the user device 106 of the user 104.

At step 422, the server system 200 receives the n^{th} user response in response to the n^{th} user authentication request from the user device 106 of the user 104.

At step 424, the server system 200 checks whether the n^{th} user response submitted by the user 104 as a response to the n^{th} user authentication request is correct. In one example, the user authentication engine 226 may check whether the n^{th} user response submitted by the user 104 is correct.

If the n^{th} user response submitted by the user 104 is incorrect, the server system 200 marks the user 104 as a non-genuine user 104, i.e., the user 104 is invalidated, at 412.

Otherwise, at 426, the server system 200 authenticates the user 104 as a genuine user 104.

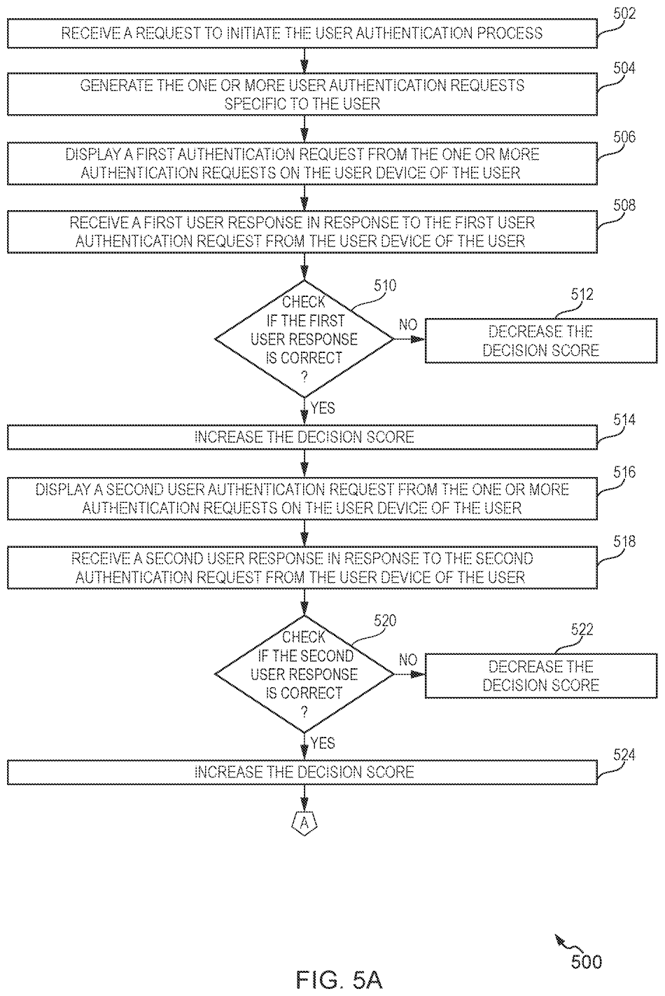

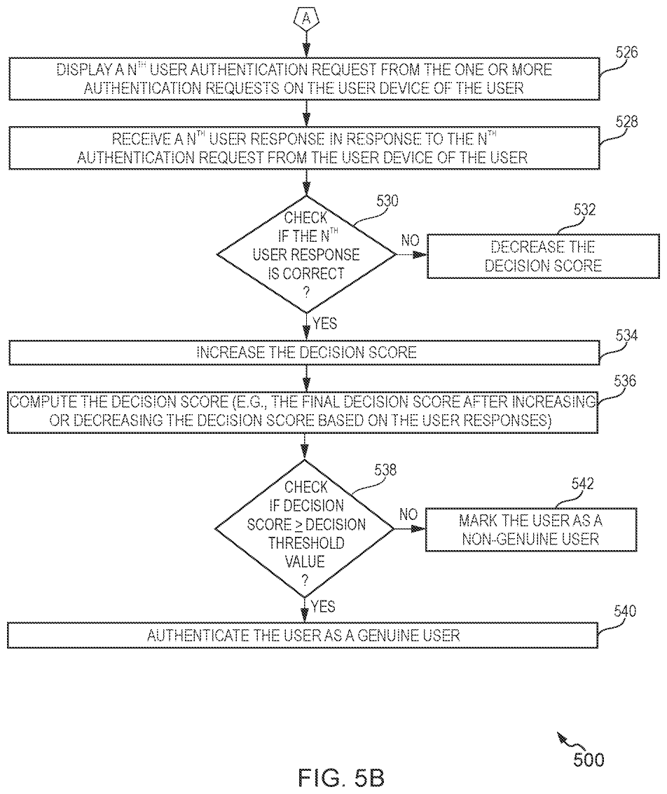

FIGS. 5A-5B, collectively, provide a data flow diagram representation 500 for performing user authentication, in accordance with another embodiment of the present disclosure. The sequence of operations of the representation 500 may not be necessarily executed in the same order as they are presented. Further, one or more operations may be grouped together and performed in form of a single step, or one operation may have several sub-steps that may be performed in parallel or in a sequential manner. It is to be noted that to explain the process steps of FIG. 5, references may be made to system elements of FIG. 1 and FIG. 2.

At 502, the server system 200 receives a request to initiate the user authentication process. In one example, the request to initiate the user authentication process may be received from a customer (e.g., the user 104) who is unable to login inside his/her account associated with the entity 108. In some non-limiting example, the request to initiate the user authentication process may be received via a secure protocol such as a Hypertext Transfer Protocol (HTTP), a Secure Socket Lock (SSL), and the like.

At 504, the server system 200 generates the one or more user authentication requests specific to the user 104. It is to be noted that each of the one or more user authentication requests is different than the other user authentication requests. In addition, the server system 200 may generate ‘n’ number of the one or more user authentication requests based on the user 104, where ‘n’ is a natural number. A detailed explanation of the generation of the one or more user authentication requests has been provided in detail with reference to FIG. 2, and therefore, it is not reiterated for the sake of brevity. It is noted that the server system 200 determines the number of user authentication requests to be issued to the user 104 such that the number ‘n’ is appropriate to reasonably authenticate the identity of the user 104 with a high probability. In an example, the server system 200 may generate five user authentication requests for a user A. In another example, the server system 200 may generate seven user authentication requests for a user B, and so on.

In an example, if the at least data field used for determining the one or more user authentication requests is an address or a location, the server system 200 starts by determining an appropriate proximity for determining the one or more relevant data points, i.e., the distance within which the server system 200 should search or access relevant data points from the third-party server 112 or service provider (such as but not limited to, Google Places® API). In particular, the distance or proximity for searching the relevant data points can be provided by the user 104, the entity 108, or the server system 200 itself. In one example, the server system 200 can determine the distance or proximity based at least on, a population density in the neighborhood of the user 104. In particular, the server system 200 may classify at first, the population density into rural, suburban, or urban categories. Then, the server system 200 may set the proximity of search to a higher distance when the population density is determined to be rural whereas, the proximity of search is set to a lower distance when the population density is determined to be urban.

As may be understood, there are fewer relevant locations that the user 104 may remember in the rural area as opposed to many relevant locations within a small distance within the urban area. Once the proximity is determined, the server system 200 performs a search via the third-party service provider. In particular, the search entails requesting entities (could be businesses, shops, landmarks, points of interest, etc., among other suitable locations that have a high likelihood of being identified by the user 104, these locations may be determined by the server system 200) within the specified proximity of the address. In response to the search, the third party server 112 returns a list of locations that match the search criteria.

In an embodiment, the relevance engine 220 of the server system 200 may determine a prevalence score as well in addition to the relevance score. The prevalence score indicates how prevalent or how well known the entity 108 is, e.g., a local bank may be determined to be more prevalent than a local road within the specified proximity of the user 104. The relevance engine 222 may use the relevance score, the prevalence score along with some other factors (such as the number of business reviews, etc.) to eliminate entities that are likely to be unknown or irrelevant to the user 104 and therefore not a good fit to be selected as the plurality of relevant data points for the user-specific challenge. Further, the server system 200 may receive a set of images associated with the plurality of relevant and unrelated data points from the third-party server 112 or one or more data repositories 122 (in the scenario of the suitable data field being a location or address) to generate the user-specific challenge. However, in a scenario where no images are available for a prevalent entity such as the bank, then the entity is discarded and a new search is done for a different prevalent entity.

In various embodiments, the prevalence score may be static or it may be fine-tuned by the machine learning model over time or during operations to adapt over time based on the user's success rates. In another embodiment, since the server system 200 cannot control the quality of images among other data received from the third-party servers 112 or service providers, therefore the server system 200 may also determine the suitability of the data being collected from the third-party servers 112 or the one and more data repository for generating the authentication challenge requests. In particular, the server system 200 may also perform data cleansing functions on the received data before processing it to generate the authentication challenge request.

In an alternate example, instead of real-life locations, the server system 200 may also rely on locations within the metaverse to generate the one or more user-specific authentication challenge requests. For example, the places that the user 104 has visited in the metaverse in the past may be used as relevant data points while generating the authenticating challenge.

In another example, if the suitable data field is text-based information such as hobbies, interests, etc., or audio and video data then, then the server system 200 starts by determining or extracting relevant information from the at least one data field. For example, relevant information such as the name of entities, topics, personal information, faces, accents, sentiment, etc., among other suitable information may be extracted from the suitable data field. An example of such a user 104 summary includes that ‘the subject is male, lives in a suburb of Manchester, and once bought food at the concession stand in the Old Trafford stadium’.

This relevant information allows the server system 200 to determine the summary of the user 104, this summary (i.e., relevant data point), and then the server system 200 determines unrelated data points. For example, a set of questions with correct answers and incorrect answers may be determined by the server system 200 and used to create the one or more user-specific authentication challenge requests. An example of a question for the user-specific challenge is ‘Please pick the jersey of your favorite sports team among several jerseys’. Further, the correct answer to such a question can be the jersey of ‘Manchester United’. In a specific example, rather than simply asking questions, the server system 200 may access images associated with the plurality of relevant and unrelated data points from a third-party server 112 and display those instead to the user 104, thereby ensuring a visually appealing user-specific challenge.

At 506, the server system 200 displays a first user authentication request from the one or more authentication requests on the user device 106 of the user 104. In some non-limiting examples, the server system 200 may display the one or more user authentication requests on the user device 106 via engagement channels including, for example, electronic mail (e-mail), short message service (SMS), and the like.

At 508, the server system 200 receives a first user response in response to the first user authentication request from the user device 106 of the user 104. In some non-limiting examples, the user 104 may provide the first user response via mouse click, keyboard entry, touch-based input, gesture input (in the case of AR/VR devices, etc.), and the like.

At 510, the server system 200 checks whether the first user response submitted by the user 104 as a response to the first user authentication request is correct.

If the first user response submitted by the user 104 is incorrect, at 512, the server system 200 decreases the decision score with a pre-defined value ‘k’, where ‘k’ is a natural number.

Otherwise, at 514, if the first user response submitted by the user 104 is correct, then the server system 200 increases the decision score with the pre-defined value ‘k’. Initially, the server system 200 may initialize the decision score with a value ‘i’, where ‘i’ is a natural number. In some non-limiting examples, the server system 200 may initialize the decision score as 0, 10, 100, and the like. Further, the server system 200 may pre-define that the decision score may be increased or decreased based on the value ‘k’. For example, if the user authentication response submitted by the user 104 in response to the user authentication request is incorrect, then the decision score may be decreased by a value 2. Otherwise, if the user authentication response submitted by the user 104 in response to the user authentication request is correct, then the decision score may be increased by a value 2.

At 516, the server system 200 displays a second user authentication request from the one or more authentication requests on the user device 106 of the user 104.

At 518, the server system 200 receives a second user response in response to the second user authentication request from the user device 106 of the user 104.

At 520, the server system 200 checks whether the second user response submitted by the user 104 as a response to the second user authentication request is correct. In one example, the user authentication engine 226 may check whether the second user response submitted by the user 104 is correct.

If the second user response submitted by the user 104 is incorrect, at 522, the server system 200 decreases the decision score with the pre-defined value ‘k’.

Otherwise, at 524, if the second user response submitted by the user 104 is correct, then the server system 200 increases the decision score with the pre-defined value ‘k’.

At 526, the server system 200 displays n^{th} user authentication request from the one or more authentication requests on the user device 106 of the user 104.

At step 528, the server system 200 receives n^{th} user response in response to the n^{th} user authentication request from the user device 106 of the user 104.

At step 530, the server system 200 checks whether the n^{th} user response submitted by the user 104 as a response to the n^{th} user authentication request is correct. In one example, the user authentication engine 226 may check whether the n^{th} user response submitted by the user 104 is correct.

If the n^{th} user response submitted by the user 104 is incorrect, at 532, the server system 200 decreases the decision score with the pre-defined value ‘k’.

Otherwise, at 534, if the n^{th} user response submitted by the user 104 is correct, then the server system 200 increases the decision score with the pre-defined value ‘k’.

At 536, the server system 200 computes the decision score (e.g., the final decision score after increasing or decreasing the decision score based on the user responses).

At 538, the server system 200 checks whether the computed decision score is at least equal to (i.e., greater than or equal to) the pre-defined threshold decision score, i.e., the decision threshold value.

If the computed decision score is at least equal to (i.e., greater than or equal to) the pre-defined threshold decision score, at 540, the server system 200 authenticates the user 104 as a genuine user.

Otherwise, at 542, if the computed decision score is less than the pre-defined threshold decision score, the server system 200 marks the user 104 as a non-genuine user, i.e., the user 104 is invalidated. In addition, the server system 200 may block the access of the user 104. For example, the server system 200 may not allow the user 104 to access the website associated with the entity 108.

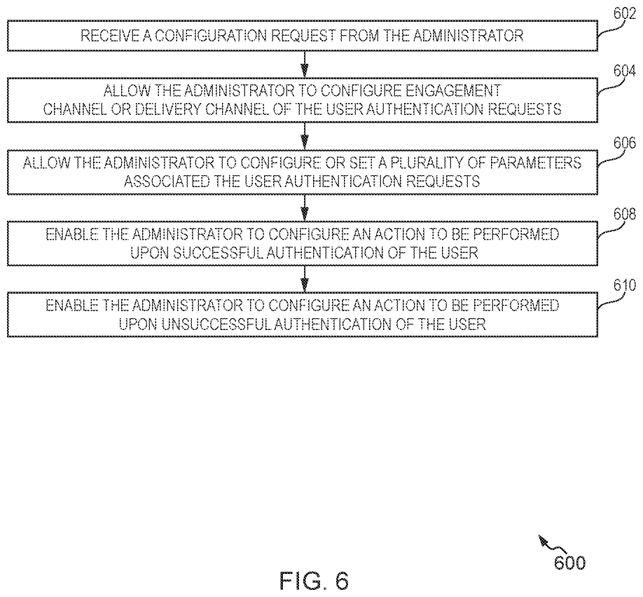

FIG. 6 is a data flow diagram representation 600 for configuring the user authentication application, in accordance with an embodiment of the present disclosure. The sequence of operations of the representation 600 may not be necessarily executed in the same order as they are presented. Further, one or more operations may be grouped together and performed in form of a single step, or one operation may have several sub-steps that may be performed in parallel or in a sequential manner. It is to be noted that to explain the process steps of FIG. 6, references may be made to system elements of FIG. 1 and FIG. 2.

At 602, the server system 200 receives a configuration request from the administrator 120. In an example, the administrator 120 may be a representative of the entity 108. In another example, the administrator 120 may be associated with the user authentication application. In yet another example, the administrator 120 is a person who wants to provide user authentication service to its customers (e.g., the user 104).

At 604, the server system 200 allows the administrator 120 to configure the engagement channel or delivery channel of the user authentication requests. In some non-limiting examples, the delivery channels may include e-mail, SMS, embedded widgets, notifications, third-party messaging services, over-the-air (OTA) delivery, and the like. In one implementation, the administrator 120 may run the user authentication application 114 on an administrator device (the administrator device can be identical to the user device 106) (not shown in figures) to configure the delivery channel of the user authentication requests for the user.

At 606, the server system 200 allows the administrator 120 to configure or set a plurality of parameters associated with the user authentication requests. In some non-limiting examples, the plurality of parameters may include challenge difficulty, number of allowed re-attempts, threshold decision score, prevalence score, time threshold, and the like.

At 608, the server system 200 enables the administrator 120 to configure an action to be performed upon successful authentication of the user 104, i.e., when the identity of the user 104 is validated. In an example, the administrator 120 may configure the server system 200 to re-direct the user 104 to a reset password webpage upon successful authentication of the user 104.

At 610, the server system 200 enables the administrator 120 to configure an action to be performed upon unsuccessful authentication of the user 104, i.e., when the identity of the user 104 is invalidated. In an example, the administrator 120 may configure the server system 200 to re-direct the user 104 to a webpage displaying “authentication failed” upon unsuccessful authentication of the user 104.

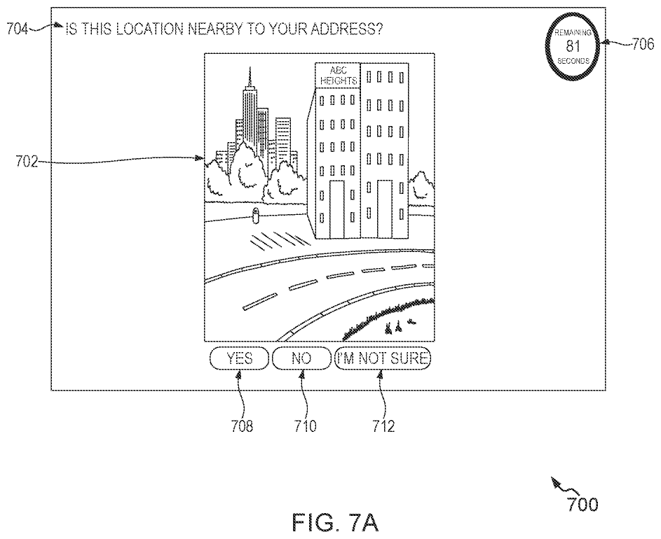

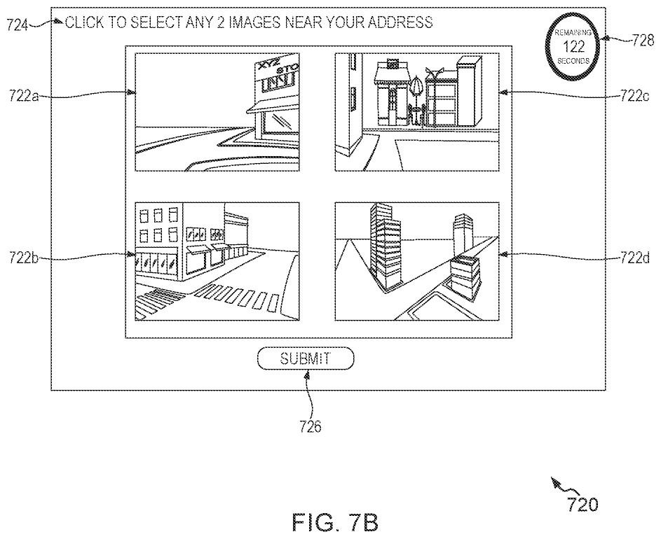

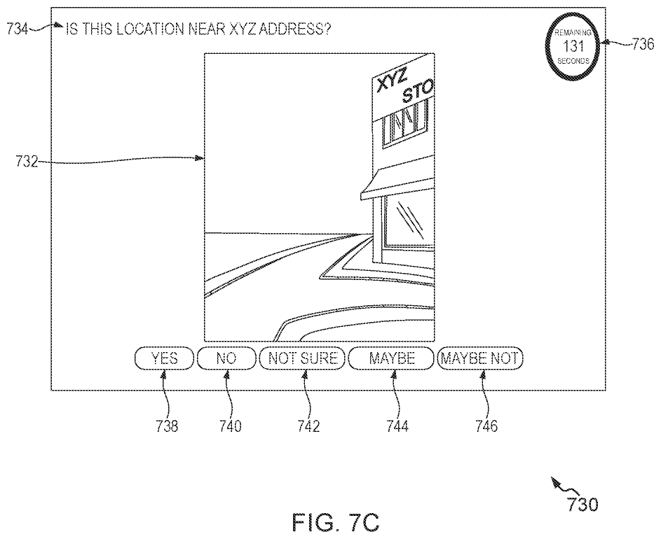

FIGS. 7A-7C, collectively, represents various graphical user interfaces (GUIs) rendered on the user device 106 for displaying user authentication requests to the user 104, in accordance with various embodiments of the present disclosure.

FIG. 7A represents an exemplary UI 700 rendered on the user device 106 of the user 104, in accordance with an embodiment of the present disclosure. The UI 700 may be displayed in the user device 106 once the user 104 initiates the user authentication process. It is assumed that the at least one data field is location data, and therefore, the user authentication request is generated based on relevant data points and unrelated data points (e.g., randomly selected images that are unrelated or unassociated with the location data of the user 104). In UI 700, an image (see, 702) is displayed on the user device 106 of the user 104. The image 702 may be of a relevant location (i.e., location known to the user 104) or an unrelated or random location (i.e., location unknown to the user 104) since the at least one data field selected is of location data. In UI 700, the user is also presented with a question asking, “Is this location nearby to your address?” (see, 704).

In addition, a timer (see, 706) is also displayed in the UI 700. In some non-limiting examples, the timer can be of 15 seconds, 30 seconds, 45 seconds, and the like. The user 104 has to provide a user response stating whether the user 104 is aware of the displayed at least one data field (i.e., location) within the time period displayed in the timer.

The UI 700 may allow the user 104 to provide the user authentication response corresponding to the user authentication request. The UI 700 allows the user to select “YES” button (see, 708) if the displayed location is nearby to the user's residential address, “NO” button (see, 710) if the displayed location is not nearby to the user's residential address, or “I'M NOT SURE” button (see 712) if the user 104 is not sure whether the displayed location is nearby to the user's residential address, as the user response. The user 104 may provide the user response via mouse click, keyboard key press, gesture, and the like. Upon selecting an option (708, 710, or 712), the UI 700 may display another user authentication challenge (based on audio data, user behavior data, etc.) to the user 104. In one example scenario, the UI 700 may display ‘z’ number of user authentication requests on the user device 106 of the user 104, where ‘z’ is a natural number.

FIG. 7B represents an exemplary UI 720 rendered on the user device 106 of the user 104, in accordance with another embodiment of the present disclosure. In UI 720, various images (see, 722a-722d) associated with the plurality of relevant data points and the plurality of unrelated data points are displayed on the user device 106 of the user 104. In addition, the user 104 is presented with a text saying, “CLICK TO SELECT ANY 2 IMAGES NEAR YOUR ADDRESS?” (see, 724). More specifically, the user 104 is asked to select any 2 images as the user responses.

In an example, any two images from the images 722a-722d are generated based on the relevant data points (i.e., locations known to the user 104) and the remaining images are generated based on the unrelated data points (i.e., locations unknown to the user 104). The user 104 may provide the user response by selecting any two images from the images 722a-722d. The user 104 may click or tap once on the images to select the images. The user 104 may then click/press/tap on a SUBMIT button (see, 726) to submit the user selection.

Further, a timer (see, 728) is also displayed in the UI 720. In some non-limiting examples, the timer can be of 20 seconds, 40 seconds, 50 seconds, and the like. The user 104 has to select the two images from the images 722a-722d within the time period displayed in the timer.

In an example, once the user 104 clicks/presses/taps on the “SUBMIT” button (see, 726), a second user authentication request may be rendered on the user device 106 of the user 104. The second user authentication request may include one or more questions based on the selected relevant data points (i.e., the two images of the locations selected by the user 104) in the first user authentication request displayed in the UI 720. In an example, the second user authentication request may be generated by selecting the two images as the at least one data point to generate relevant and unrelated questions for the user 104 to answer for authenticating his/her identity.

In an example, questions such as “How long does it take to drive there approximately from your address?”, “What other businesses are nearby to your address?”, and the like may be asked in the second user authentication request. It is to be noted that in the above stated approach, the one or more user authentication requests are correlated to each other, i.e., the second user authentication request is derived from the user response of the first user authentication request. Therefore, in this approach, the overall accuracy of the authentication process is significantly improved. Further, in this approach, even if the user 104 is not good at recognizing the relevant locations (i.e., the relevant data points), the user 104 may still complete the authentication process by answering the questions derived from the selected relevant data points (i.e., the two images selected by the user 104).

It is to be noted that the UI 720 is similar to the UI 700 since the user 104 is asked to provide the user authentication response for the user authentication request in both the UI 720 and UI 700. However, in the UI 700, the user 104 is asked to individually select the images, whereas in the UI 720, the user 104 is asked to select multiple images at once.

FIG. 7C represents an exemplary UI 730 rendered on the user device 106 of the user 104, in accordance with yet another embodiment of the present disclosure.

In UI 730, an image (see, 732) is displayed on the user device 106 of the user 104. The image 732 may either be of a relevant location (i.e., location known to the user 104) or an unrelated or random location (i.e., location unknown to the user 104) since the at least one data field selected is of location data. In UI 730, the user 104 is also presented with a question asking, “Is this location near XYZ address?” (see, 734). In addition, a timer (see, 736) is displayed in the UI 730. More specifically, the user 104 is asked if the location displayed in the image (see, 732) near XYZ address written in the text (see, 734).

In some non-limiting examples, the timer can be of 20 seconds, 40 seconds, 50 seconds, 200 seconds, and the like. The timer displayed in the UI 730 is similar to the timer displayed in the UI 700.

The UI 730 may allow the user 104 to provide the user authentication response corresponding to the user authentication request. The UI 730 allows the user 104 to click/press/tap on “YES” button (see, 738) if the displayed location is nearby to XYZ address. In addition, the UI 730 allows the user 104 to click/press/tap on “NO” button (see, 740) if the displayed location is not nearby to XYZ address. Further, the UI 730 allows the user 104 to click/press/tap on “NOT SURE” button (see, 742) if the user 104 is not sure whether the displayed location is nearby to XYZ address, as the user response.

Furthermore, the UI 730 allows the user 104 to click/press/tap on “MAYBE” button (see, 744) if the user 104 thinks that the displayed location in nearby to XYZ address but is not 100 percent sure. Moreover, the UI 730 allows the user 104 to click/press/tap on “MAYBE NOT” button (see, 746), if the user 104 is not confident regarding their selection. In an example, the user 104 may click/press/tap on “NOT SURE” button if they have very low confidence on their selection, otherwise the user 104 may click/press/tap on “MAYBE NOT” button if they have medium confidence on their selection, or the user 104 may click/press/tap on “MAYBE” button if they have relatively high confidence on their selection.

The user 104 may provide the user response via mouse click, keyboard key press, gesture, and the like. Upon selecting an option (i.e., 738, 740, 742, 744, or 746), the UI 730 may display another user authentication challenge request (based on audio data, user behavior data, etc.) to the user 104. In one example scenario, the UI 730 may display ‘z’ number of user authentication requests on the user device 106 of the user 104, where ‘z’ is a natural number.

In one implementation, the server system 200 is configured to calculate a risk score based on the selection of the user 104 from the options “YES”, “NO”, “NOT SURE”, “MAYBE”, and “MAYBE NOT” (738, 740, 742, 744, and 746, respectively). In one example, the server system 200 calculates the risk score to determine the probability of the user 104 being genuine user. In an example, the server system 200 compares the risk score with a predetermined threshold value. If the risk score is at least equal to (i.e., greater than or equal to) the predetermined threshold, the server system 200 may identify the user 104 as genuine user. Otherwise, if the risk score is less than the predetermined threshold, the server system 200 may identify the user 104 as non-genuine user.

It is to be noted that the UI 730 is similar to the UI 700; however in the UI 730, more options are provided to the user 104 for selection.

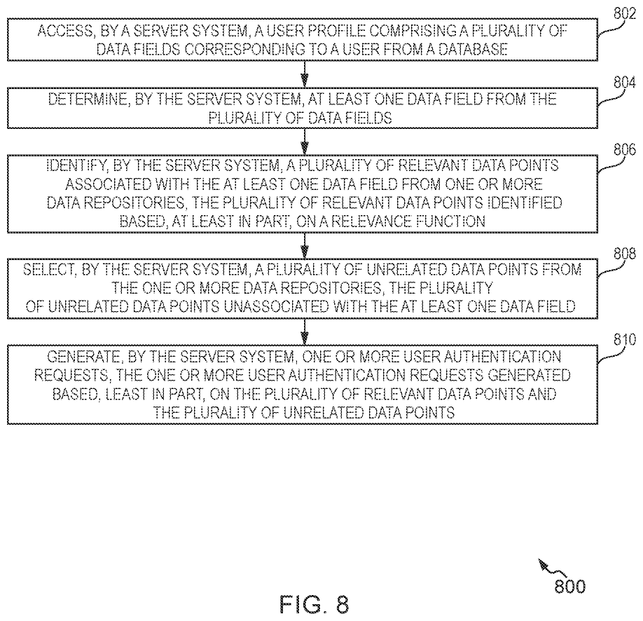

FIG. 8 is a process flow chart of a computer-implemented method 800 for performing user authentication, in accordance with an embodiment of the present disclosure. The method 800 depicted in the flow chart may be executed by, for example, a computer system. The computer system is identical to the server system 200. Operations of the flow chart of the method 800, and combinations of operation in the flow chart of the method 800, may be implemented by, for example, hardware, firmware, a processor, circuitry, and/or a different device associated with the execution of software that includes one or more computer program instructions. It is noted that the operations of the method 800 can be described and/or practiced by using a system other than these computer systems. The method 800 starts at operation 802. At operation 802, the method 800 includes accessing, by the server system 200, the user profile including the plurality of data fields corresponding to the user 104 from the database 116.

At operation 804, the method 800 includes determining by the server system 200, at least one data field from the plurality of data fields. The at least one data field corresponds to the valid data field of the user 104. In an embodiment, the at least one data field is determined via implementation of the machine learning model (i.e., the user authentication model 228). In another embodiment, the administrator 120 may manually determine the at least one data field.

At operation 806, the method 800 includes identifying, by the server system 200, the plurality of relevant data points associated with the at least one data field from the one or more data repositories 122. The plurality of relevant data points is identified based, at least in part, on the relevance function.

At operation 808, the method 800 includes selecting, by the server system 200, the plurality of unrelated data points from the one or more data repositories 122. The plurality of unrelated data points is unrelated or unassociated with the at least one data field. In an example, the plurality of unrelated data points may be randomly selected from the one or more data repositories 122.

At operation 810, the method 800 includes generating, by the server system 200, the one or more user authentication requests. The one or more user authentication requests are generated based, at least in part, on the plurality of relevant data points and the plurality of unrelated data points.

The sequence of operations of the method 800 need not be necessarily executed in the same order as they are presented. Further, one or more operations may be grouped together and performed in form of a single step, or one operation may have several sub-steps that may be performed in parallel or in a sequential manner.

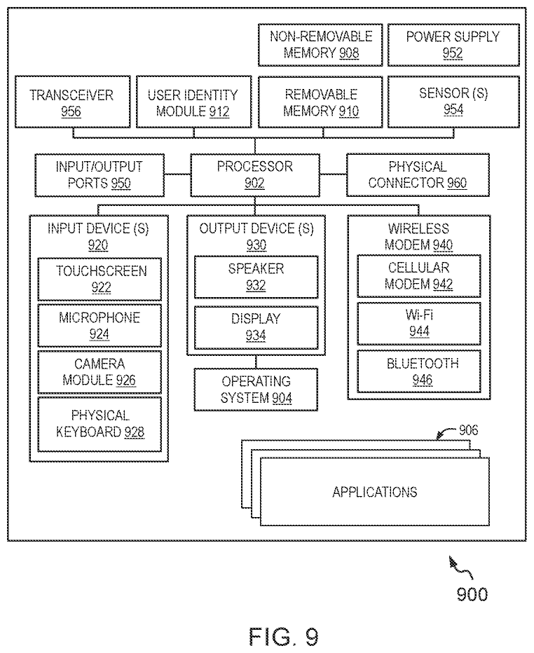

FIG. 9 is a simplified block diagram of an electronic device 900 capable of implementing various embodiments of the present disclosure. In an example, the electronic device 900 may correspond to the user device 106 of FIG. 1. In another example, the electronic device 900 may correspond to the administrator device (not shown in figures) of the administrator. The electronic device 900 is depicted to include one or more applications 906. In one example, the one or more applications 906 may include the user authentication application 114 of FIG. 1. The user authentication application 114 can be an instance of the application that is hosted and managed by the server system 200. One of the one or more applications 906 on the electronic device 900 is capable of communicating with a server system for performing the user authentication as explained above.

It should be understood that the electronic device 900 as illustrated and hereinafter described is merely illustrative of one type of device and should not be taken to limit the scope of the embodiments. As such, it should be appreciated that at least some of the components described below in connection with the electronic device 900 may be optional and thus in an embodiment may include more, less, or different components than those described in connection with the embodiment of the FIG. 9. As such, among other examples, the electronic device 900 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 900 includes a controller or a processor 902 (e.g., a signal processor, microprocessor, ASIC, or other control and processing logic circuitry) for performing such tasks as signal coding, data processing, image processing, input/output processing, power control, and/or other functions. An operating system 904 controls the allocation and usage of the components of the electronic device 900 and supports for one or more operations of the application (see, the applications 906), such as the user authentication application 114 that implements one or more of the innovative features described herein. In addition, the applications 906 may include common mobile computing applications (e.g., email applications, calendars, contact managers, web browsers, messaging applications) or any other computing application.

The illustrated electronic device 900 includes one or more memory components, for example, a non-removable memory 908 and/or removable memory 910. The non-removable memory 908 and/or the removable memory 910 may be collectively known as a database in an embodiment. The non-removable memory 908 can include RAM, ROM, flash memory, a hard disk, or other well-known memory storage technologies. The removable memory 910 can include flash memory, smart cards, or a Subscriber Identity Module (SIM). The one or more memory components can be used for storing data and/or code for running the operating system 904 and the applications 906. The electronic device 900 may further include a user identity module (UIM) 912. The UIM 912 may be a memory device having a processor built in. The UIM 912 may include, for example, a subscriber identity module (SIM), a universal integrated circuit card (UICC), a universal subscriber identity module (USIM), a removable user identity module (R-UIM), or any other smart card. The UIM 912 typically stores information elements related to a mobile subscriber. The UIM 912 in form of the SIM card is well known in Global System for Mobile (GSM) communication systems, Code Division Multiple Access (CDMA) systems, or with third generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 900 can support one or more input devices 920 and one or more output devices 930. Examples of the input devices 920 may include, but are not limited to, a touch screen/a display screen 922 (e.g., capable of capturing finger tap inputs, finger gesture inputs, multi-finger tap inputs, multi-finger gesture inputs, or keystroke inputs from a virtual keyboard or keypad), a microphone 924 (e.g., capable of capturing voice input), a camera module 926 (e.g., capable of capturing still picture images and/or video images) and a physical keyboard 928. Examples of the output devices 930 may include, but are not limited to, a speaker 932 and a display 934. Other possible output devices can include piezoelectric or other haptic output devices. Some devices can serve more than one input/output function. For example, the touch screen 922 and the display 934 can be combined into a single input/output device.

A wireless modem 940 can be coupled to one or more antennas (not shown in FIG. 9) and can support two-way communications between the processor 902 and external devices, as is well understood in the art. The wireless modem 940 is shown generically and can include, for example, a cellular modem 942 for communicating at long range with the mobile communication network, a Wi-Fi compatible modem 944 for communicating at short range with an external Bluetooth-equipped device or a local wireless data network or router, and/or a Bluetooth-compatible modem 946. The wireless modem 940 is typically configured for communication with one or more cellular networks, such as a GSM network for data and voice communications within a single cellular network, between cellular networks, or between the electronic device 900 and a public switched telephone network (PSTN).

The electronic device 900 can further include one or more input/output ports 950, a power supply 952, one or more sensors 954 for example, an accelerometer, a gyroscope, a compass, or an infrared proximity sensor for detecting the orientation or motion of the electronic device 900 and biometric sensors for scanning biometric identity of an authorized user, a transceiver 956 (for wirelessly transmitting analog or digital signals) and/or a physical connector 960, which can be a USB port, IEEE 1294 (FireWire) port, and/or RS-232 port. The illustrated components are not required or all-inclusive, as any of the components shown can be deleted and other components can be added.

The disclosed method with reference to FIGS. 4, 5, 6, and 8, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components)) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the computing device 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a non-transitory computer-readable storage medium, wherein the computer programs are configured to cause a processor or computer to perform one or more operations. A non-transitory computer-readable storage medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-RAY (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method for performing authentication of a user, the method comprising:
accessing, by a server system, a user profile comprising a plurality of data fields corresponding to the user from a database;
determining, by the server system, at least one data field from the plurality of data fields;
identifying, by the server system, a plurality of relevant data points associated with the at least one data field from one or more data repositories, the plurality of relevant data points identified based, at least in part, on a relevance function;
selecting, by the server system, a plurality of unrelated data points from the one or more data repositories, the plurality of unrelated data points unassociated with the at least one data field; and
generating, by the server system, one or more user authentication requests, the one or more user authentication requests generated based, at least in part, on the plurality of relevant data points and the plurality of unrelated data points.

2. The computer-implemented method as claimed in claim 1, wherein identifying the plurality of relevant data points further comprises:
determining, by the server system, a data type of the at least one data field;
accessing, by the server system, one or more data points from the one or more data repositories based at least on the determined data type of the at least one data field;
assigning, by the server system, relevance scores to the one or more data points based, at least in part, on a machine learning model, wherein a relevance score is assigned to each data point of the one or more data points; and
selecting, by the server system, the plurality of relevant data points based, at least in part, on the relevance scores.

3. The computer-implemented method as claimed in claim 1, wherein each of the one or more user authentication requests is valid for a pre-defined time interval.

4. The computer-implemented method as claimed in claim 1, further comprising:
displaying, by the server system, the one or more user authentication requests on a graphical user interface (GUI) rendered on a user device of the user.

5. The computer-implemented method as claimed in claim 4, further comprising:
receiving, by the server system, one or more user responses corresponding to the one or more user authentication requests from the user device of the user, wherein each user response of the one or more user responses is received corresponding to each user authentication request of the one or more user authentication requests.

6. The computer-implemented method as claimed in claim 1, wherein the plurality of data fields comprises at least one of location data points, auditory data points, video data points, user data points, and user behavior data points.

7. The computer-implemented method as claimed in claim 5, further comprising:
calculating, by the server system, a decision score based, at least in part, on the one or more user responses; and
comparing, by the server system, the calculated decision score with a pre-determined threshold decision score.

8. The computer-implemented method as claimed in claim 7, wherein upon determining that the calculated decision score is at least equal to the pre-determined threshold decision score, further comprising:
authenticating, by the server system, the user as a genuine user.

9. The computer-implemented method as claimed in claim 7, wherein upon determining that the calculated decision score is less than the pre-determined threshold decision score, further comprising:
identifying, by the server system, the user as a non-genuine user.

10. The computer-implemented method as claimed in claim 1, further comprising:
collecting, by the server system, the plurality of data fields corresponding to the user from the one or more data repositories; and
updating, by the server system, the user profile based, at least in part, on the plurality of data fields.

11. The computer-implemented method as claimed in claim 4, wherein generating the one or more user authentication requests further comprises:
identifying, by the server system, a device type of the user device of the user;
determining, by the server system, a pre-defined user interface (UI) for generation of the one or more user authentication requests based, at least in part, on the identified device type; and
adapting, by the server system, the one or more user authentication requests based, at least in part, on the determined pre-defined UI.

12. A server system, comprising:
a communication interface;
a memory comprising executable instructions; and
a processor communicably coupled to the communication interface and the memory, the processor configured to cause the server system to at least:
access a user profile comprising a plurality of data fields corresponding to a user from a database;
determine at least one data field from the plurality of data fields;
identify a plurality of relevant data points associated with the at least one data field from one or more data repositories, the plurality of relevant data points identified based, at least in part, on a relevance function;
select a plurality of unrelated data points from the one or more data repositories, the plurality of unrelated data points unassociated with the at least one data field; and
generate one or more user authentication requests, the one or more user authentication requests generated based, at least in part, on the plurality of relevant data points and the plurality of unrelated data points.

13. The server system as claimed in claim 12, wherein for identifying the plurality of relevant data points, the server system is further caused at least in part to:
determine a data type of the at least one data field;
access one or more data points from the one or more data repositories based at least on the determined data type of the at least one data field;
assign relevance scores to the one or more data points based, at least in part, on a machine learning model, wherein a relevance score is assigned to each data point of the one or more data points; and
select the plurality of relevant data points based, at least in part, on the relevance scores.

14. The server system as claimed in claim 12, wherein each of the one or more user authentication requests is valid for a pre-defined time interval.

15. The server system as claimed in claim 12, wherein the server system is further caused, at least in part, to:
display the one or more user authentication requests on a graphical user interface (GUI) rendered on a user device of the user.

16. The server system as claimed in claim 12, wherein the server system is further caused, at least in part, to:
receive one or more user responses corresponding to the one or more user authentication requests from a user device of the user, wherein each user response of the one or more user responses is received corresponding to each user authentication request of the one or more user authentication requests.

17. A computer system, comprising:
a memory comprising executable instructions; and
a processor configured to execute the instructions to cause the computer system, at least in part, to:
access a user profile comprising a plurality of data fields corresponding to a user from a database;
determine at least one data field from the plurality of data fields;
identify a plurality of relevant data points associated with the at least one data field from one or more data repositories, the plurality of relevant data points identified based, at least in part, on a relevance function;
select a plurality of unrelated data points from the one or more data repositories, the plurality of unrelated data points unassociated with the at least one data field; and
generate one or more user authentication requests, the one or more user authentication requests generated based, at least in part, on the plurality of relevant data points and the plurality of unrelated data points.

18. The computer system as claimed in claim 17, wherein for identifying the plurality of relevant data points, the computer system is further caused, at least in part, to:
determine a data type of the at least one data field;
access one or more data points from the one or more data repositories based at least on the determined data type of the at least one data field;
assign relevance scores to the one or more data points based, at least in part, on a machine learning model, wherein a relevance score is assigned to each data point of the one or more data points; and
select the plurality of relevant data points based, at least in part, on the relevance scores.

19. The computer system as claimed in claim 18, wherein the computer system is further caused, at least in part, to:
display the one or more user authentication requests on a graphical user interface (GUI) rendered on a user device of the user.

20. The computer system as claimed in claim 18, wherein the computer system is further caused, at least in part, to:
calculate a decision score based, at least in part, on the one or more user responses; and compare the calculated decision score with a pre-determined threshold decision score.
